(19) United States
(12) Patent Application Publication
(10) Pub. No.: US 2013/0177136 A1
(43) Pub. Date: Jul. 11, 2013

(54) APPARATUS AND METHOD OF PROVIDING DUAL LINE SOURCE IRRADIATOR, DLSIR

(71) Applicants: PAUL MOSES, Ottawa (CA); STEPHEN R. SZEGLIN, Springfield, VA (US)

(72) Inventors: PAUL MOSES, Ottawa (CA); STEPHEN R. SZEGLIN, Springfield, VA (US)

(73) Assignee: STEPHEN SZEGLIN, & AL.

(21) Appl. No.: 13/346,112

(22) Filed: Jan. 9, 2012

(51) Int. Cl. G21K 5/08

(52) U.S. Cl. 378/66

(57) ABSTRACT

According to one general aspect, A blood irradiator apparatus for evenly irradiating blood bags comprising a blood canister, wherein the blood canister holds a blood bag an one or more power supply; an one or more x-ray sources, wherein the one or more x-ray sources are connected individual or together to the one or more power supply; an one or more motors to rotate the blood canister; and a vault shield. In addition, the blood irradiator apparatus for evenly irradiation blood bags further states the blood canister changes the rotation speed conditioned on a single x-ray source or a dual x-ray source. Furthermore, the blood irradiator apparatus for evenly irradiation blood bags further states the blood canister is connected to an operator control, wherein the operator control changes a rotation speed and a rotation direction or may used predetermined settings.

### CROSS REFERENCE TO RELATED APPLICATION

N/A

### FIELD OF THE INVENTION

This invention is an x-ray irradiation system using two line-type x-ray sources and a rotating sample canister to provide an x-ray irradiation system with high sample throughput, uniform dose distribution throughout the sample canister and the ability to function during several failure modes.

### BACKGROUND

Blood irradiation therapy is a procedure that is performed prior to providing patients with blood from other donors. The blood irradiation therapy is performed in two different methods. First, the blood is irradiated just prior to providing the blood to the patient in blood transfusion. The second is blood is stored in blood bags, and the blood bags are radiated and store for later use. There are many problems that are associated with blood irradiation. Irradiating blood includes whole blood, red cells, frozen cells, platelet concentrates, apheresis platelets, granulocyte concentrates, and fresh plasma. The blood can be treated with ionizing radiation such as gamma rays from 137Cs or 60Co sources, self-contained bremsstrahlung x-ray units, medical linear x-ray and electrons accelerators. The primary purpose is to inactivate viable lymphocytes to prevent transfusion-induced graft-verus-host disease (GVHD) in selected immunocompromised patients and those receiving related-donor products (ASTM 1939). The purpose of the blood irradiation is to remove the immunocompetent cells whose unwanted addition in immunodepressed patients cause a very serious and often fatal reaction of the graft. The three most common reasons for radiating the blood is to help the 1) kill diseases for aplastic patients, since the patient's body is not making enough blood cells to find off infections, 2) kill cancerous cells with patients with leukemias, lymphomas), which some individuals that donate blood may not be aware the irradiating of the blood cells stops the cancer reproducing cells in the blood, and 3) children with immune deficiency, some child may have a reaction with blood donated by the patient and reduce that reaction or disease. Therefore, it is important to irradiate the blood. Currently, there are many different types of blood bag irradiators. At present, a blood bag irradiator has two x-ray tubes placed on top and bottom of a blood bag. The problem with this is that when a tube is inactive, the dose to the blood bag irradiation is not accurate or assured. When a tube is not functioning or inoperative, the absorbed-dose rate at a reference dose position within the blood volume is not accurate that the blood bag will be consider not radiated properly. Therefore, one of ordinary skill in the art would appreciated a need to provide a system and method to irradiate the blood effectively and efficiently while performing under a x-ray source, and have a multiple redundant system to continuously irradiate blood bags.

Other problems with irradiating the blood bag is that blood bags have been irradiated for too long and thus reach a temperature too hot; which decays and ruins the blood bag. Specifically, there are many hot spots and cold spots where the blood bag is irradiated. Blood bag irradiators only turn on and off the x-ray source and then the x-rays only hits certain concentrated location on the blood bag, which results in hot and cold spots. Therefore, one of ordinary skill in the art would appreciate a need to have a system that can evenly irradiate a blood bag quickly.

### SUMMARY OF INVENTION

According to one general aspect, A blood irradiator apparatus for evenly irradiating blood bags comprising a blood canister, wherein the blood canister holds a blood bag an one or more power supply; an one or more x-ray sources, wherein the one or more x-ray sources are connected individual or together to the one or more power supply; an one or more motors to rotate the blood canister; and a vault shield. In addition, the blood irradiator apparatus for evenly irradiation blood bags further states the blood canister is connected to the one or more motors, wherein, the blood canister will rotate in clock-wise or counter clock-wise motion. Also, the blood irradiator apparatus for evenly irradiation blood bags further states the blood canister is located in the center of the one or more line x-ray sources. In addition, the blood irradiator apparatus for evenly irradiation blood bags further states the blood canister changes the rotation speed conditioned on a single x-ray source or a dual x-ray source. Furthermore, the blood irradiator apparatus for evenly irradiation blood bags further states the blood canister is connected to an operator control, wherein the operator control changes a rotation speed and a rotation direction or may used predetermined settings. Moreover, the blood irradiator apparatus for evenly irradiation blood bags further states the blood canister is connected to an internal cooling system, wherein the internal cooling system cools the blood canister. Further, the blood irradiator apparatus for evenly irradiation blood bags further states the one or more x-ray sources contain an anode and a cathode. Additionally, A blood irradiator apparatus for evenly irradiation blood bags further states the anode and the cathode of a dual x-ray tubes are inverted on opposite sides used to irradiate the blood canister, wherein the dual x-ray tubes provide an even dose distribution. Likewise, the blood irradiator apparatus for evenly irradiation blood bags further states the one or more x-ray sources irradiate the entire the blood canister. Also, the blood irradiator apparatus for evenly irradiation blood bags further states the operator control contains a CPU, a touch display apparatus, and input device, wherein the operator control is connected to the blood irradiator apparatus; and the operator control monitors internal temperature of the blood irradiator apparatus. What is more, the blood irradiator apparatus for evenly irradiation blood bags further states the dual x-ray sources irradiate the blood canister while the blood canister is rotating at a predetermined speed. Further, the blood irradiator apparatus for evenly irradiation blood bags further states the blood canister is being irradiated on the coronal plano and not being irradiated on the transversal piano. Furthermore, the blood irradiator apparatus for evenly irradiation blood bags further states the one or more x-ray sources contain a line array x-ray tube.

According to another general aspect of a method of irradiating a blood bag in a uniform dose comprising spinning a blood canister in a clock-wise or counter clock-wise direction; irradiating the blood canister while spinning in a rotational direction by using a one or more line x-ray tubes; and operating an operator control and monitoring the blood canister and the one or more line x-ray tubes.

### DESCRIPTION OF THE DRAWINGS

These and other features, aspects, and advantages of the present invention will become better understood with regard to the following description, appended claims, and accompanying drawings were:

FIG. 1 illustrates an exemplary apparatus of a blood irradiator, but not limited to illustrated component parts.

FIG. 2 illustrates the exemplary parts of a blood irradiator, but not limited to illustrated component parts.

FIG. 3 illustrates a exemplary front view of a blood irradiator apparatus, but not limited to illustrated component parts.

FIG. 4 illustrates an exemplary capture container rotation, but not limited to illustrated component parts.

FIG. 5A illustrates an exemplary top view of the capture canister, but not limited to illustrated component parts.

FIG. 5B illustrates an exemplary side view of the capture canister, but not limited to illustrated component parts.

FIG. 6A illustrates an exemplary single source intersection points of capture canister.

FIG. 6B illustrates an exemplary dual source intersection points of capture canister.

FIG. 7 illustrates the conventional x-ray source irradiation of the blood canister.

While the invention will be described connection with the preferred embodiment, it will be understood that it is not intended to limit the invention to that embodiment. On the contrary, it is intended to cover all alternatives, modifications, and equivalents, as maybe included within the spirit and scope of the invention as to be defined by claims to be filed in a non-provisional application.

### DETAILED DESCRIPTION

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized an structural and operational changes may be made without departing from the scope of the present invention.

The invention generally relates to an apparatus and method of irradiating blood bags by rotating the capture container.

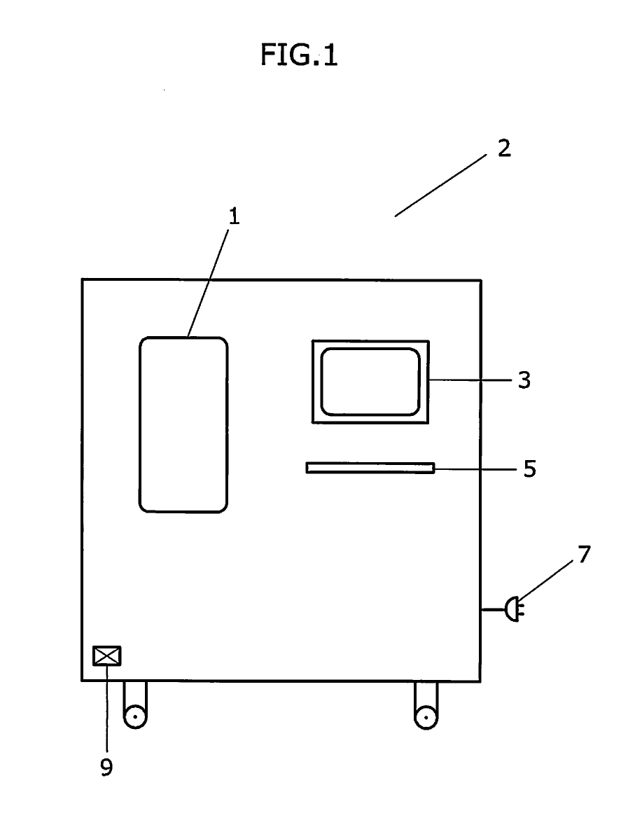

FIG. 1 shows a blood bag irradiator apparatus 2. The system, not limited to, contains a single blood bag canister 1. The blood bag canister 1 holds a blood bag which can be sealed inside a lead shield to prevent radiation from leaking out. The system contains a display 3 and keyboard 5, which is used to operate the device. The system can be modified to be adopted in any part of the world's power supply system and contains an outlet 7. The system also contains an external cooling vent 9. The display 3 and keyboard 5 are connected to a CPU which are used to operate the blood irradiation process. In addition, the operating system can be controlled manually or by used operated by pre-set functions.

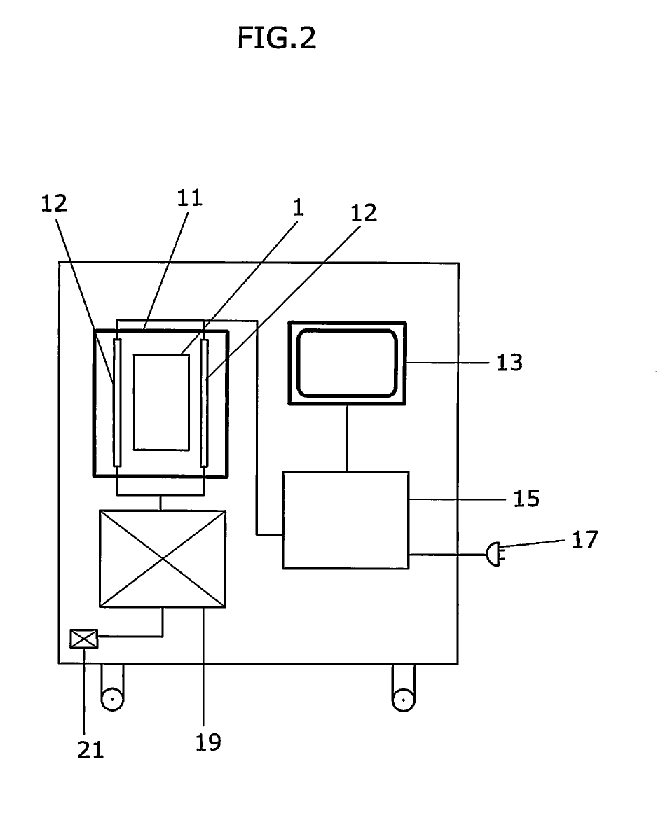

Looking specifically, FIG. 2 illustrates the component parts of a blood irradiator, but not limited to illustrated component parts. Within the blood bag irradiating apparatus 2 the system contains an internal x-ray shield 11. The x-ray shield is used to prevent radiation leakage when the blood bags are being irradiated. The irradiation chamber of the line-type x-ray source and canister will be completely enclosed with lead foil sufficiently thick enough to reduce external radiation levels to less than or equal levels established by the appropriate regulatory agency. Additionally, the shapes of the radiation field produced by line-type x-ray tubes 12 are approximate to the shape of the blood canister, which the beam does not over shoot the blood bag canister 1. This effective use of the radiation results in much less radiation being scattered and this greatly reduces the risk associated with radiation leakage. The system will display all the information about irradiating the blood bags inside the blood bag canister. The outlet plug 17 is connected to the x-ray power supply 15. The system generates large amount of heat; therefore, the system contains an internal cooling system 19 and also an external cooling vent 21. The internal cooling system may be used also to cool the blood bag and the blood bag irradiating apparatus 2. During irradiation, the blood bag temperature may increase; however, the blood bag cannot reach a certain temperature or the blood bag will spoil. Therefore, the blood bag irradiator cooling system can be used to cool the blood bag.

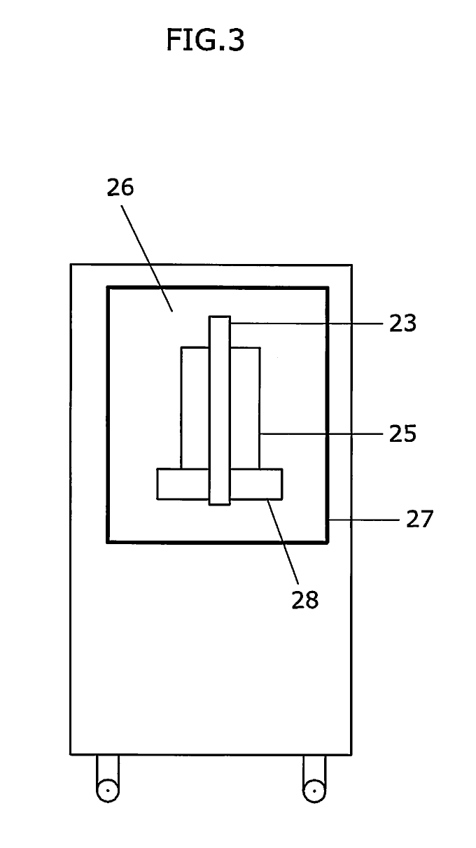

FIG. 3 illustrates a closer view of the blood bag canister 25. The blood bag canister contains an internal x-ray shield 27. The blood bag chamber 26 contains a blood bag canister 25. Connected the blood bag canister 25 is the motor device 28. A typical motor attached to a turntable assembly. Our configuration will have single turntable, rotating platform, and two motors. If a motor fails it will be detected by the control system and the back-up motor will come into operation. The motors and turntable and sized to work properly in a radiation rich environment.

The major benefit by having a rotating blood chamber is to reduced amount of time it will take to achieve the prescribed dose during the irradiation cycle. Since blood is temperature sensitive, the reduced irradiation or cycle time allows the blood to be returned to a temperature controlled, refrigerated, environment in less time than conventional irradiators thus eliminating a potential cause of spoilage.

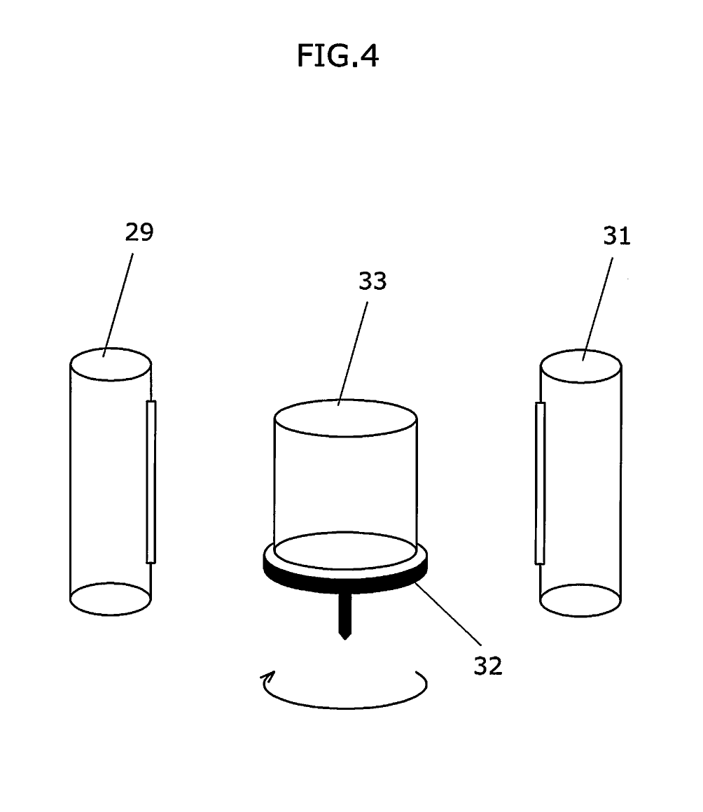

FIG. 4 illustrates the blood irradiating chamber. There are many subsystems in the dual line tube configuration, which are two line x-ray tubes, if needed, two power supplies, and one or two motor to rotate the canister. This configuration allows the user to continue to irradiate blood even if there is a failure of one of the critical component. The blood bag canister is connected to a motor. The motor will be at variable speed rotation, which in turn will change the speed of the rotation platform 32 that is attached to the blood bag container 33 located in center of the chamber. While the system is active, the first x-ray 29 and the second x-ray 31 will radiate the blood bag simultaneously. The benefit of having two dual x-rays tubes allows the system to radiate the blood bag rapidly and effectively, while cooling the blood bag simultaneously. The additional benefit is that if either x-ray tube were to malfunction, the single tube would provide enough radiation which will not stop the production of the blood irradiation. The system is capable of blood irradiation with a single x-ray tube. Furthermore, by spinning the bag at different speeds, the system will allow the blood bag to be irradiated in different location evenly. The line-type x-ray source being used is a modified electron beam tube that provides a relatively large rectangular shaped radiation field approximately 4-10 cm wide and 27-35 cm high. Therefore, the blood canister will rotate during irradiation for the blood bags to achieve a uniform dose x-radiation. The line-type x-ray sources have a much longer life cycle than a conventional x-ray tube. However, a conventional x-ray tube may be also used. The conventional x-ray tube for irradiating blood bags are described below. This is understandable since the electron emitter in a line-type x-ray source is substantially longer than the filament in a fixed anode x-ray tube. Since the power requirements in both instances are approximately the same, the short repetitive x-ray exposure cycle, beam on/off, used in blood irradiation should be better tolerated by the longer electron emitter.

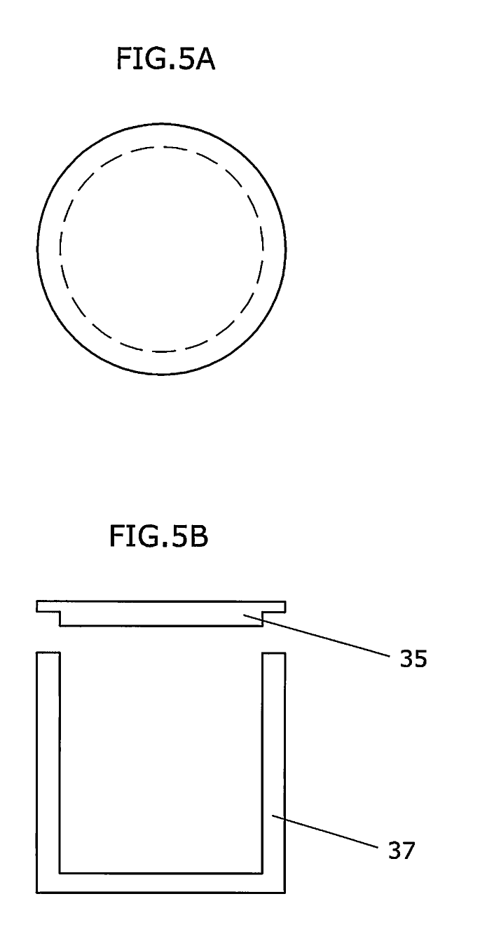

FIG. 5 illustrates a top and side view of the capture container. FIG. 5A is the top view illustrating that the blood canister, which is in a circular fashion; however, the shape maybe any shape that fits inside the chamber. The circular shape is only used for illustrative purposes and should not limit this apparatus. FIG. 5B is the side view of the blood canister. The blood canister contains a side wall 37. The side wall 37 and canister cover 35 are made of uniform material so allow for equal distribution of x-rays.

Platform rotation is variable and will depend on the diameter of the canister, the kilowatt rating of the x-ray source or sources, the x-ray dose rate, and the number of sources in use. In order to assure a uniform distribution of the radiation dose being delivered to the sample, complete rotations of 360 degrees must be accomplished. An under rotation of the platform will result in under dosing portions of the sample while an over rotation will result in over dosing portions of the sample. Rotation speed is faster for 2 x-ray sources compared to a single x-ray source.

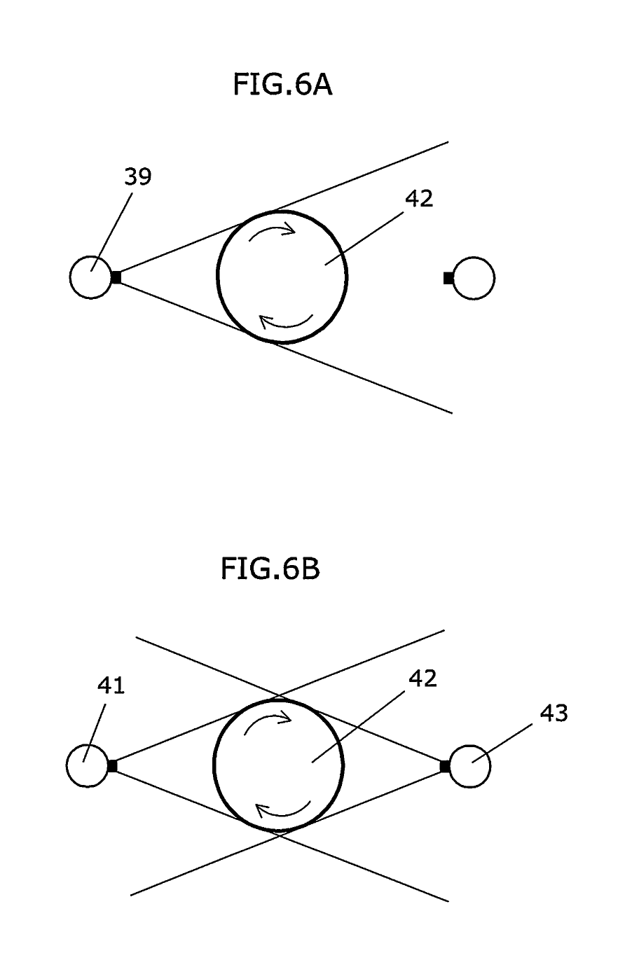

FIG. 6A illustrates a top of view of the blood canister using a single x-ray source with a rotating canister, which will work fine. The single x-ray source 39 irradiates the blood canister 42. Adding a second line tube reduces the irradiation time by 50% and allows the user to irradiate blood if one of the x-ray tubes fails.

FIG. 6B illustrates the source intersection points of blood canister. This demonstrates the x-ray tube 41 and x-ray tube 43 provide an area were the blood canister area is radiated on both sides as the blood canister is rotating. The system first starts the rotating process to a specific speed. Thereafter, the system then turns on the x-ray tube 41 and x-ray tube 43. The area entire blood canister area is radiated. This allows for the device to radiate the entire bag. However, if one of the x-ray tubes were to mal-function, the system will still continue to radiate the blood bag since either x-ray tube covers the blood bag canister.

The advantages over existing system are the dual two x-ray sources and redundant power supplies, with the blood canister rotating at variable speeds. Prior existing systems do not have rotational features with dual x-ray sources. Thus, if one of these component parts were to fail in prior existing systems, the user can not irradiate blood bags until the system is repaired.

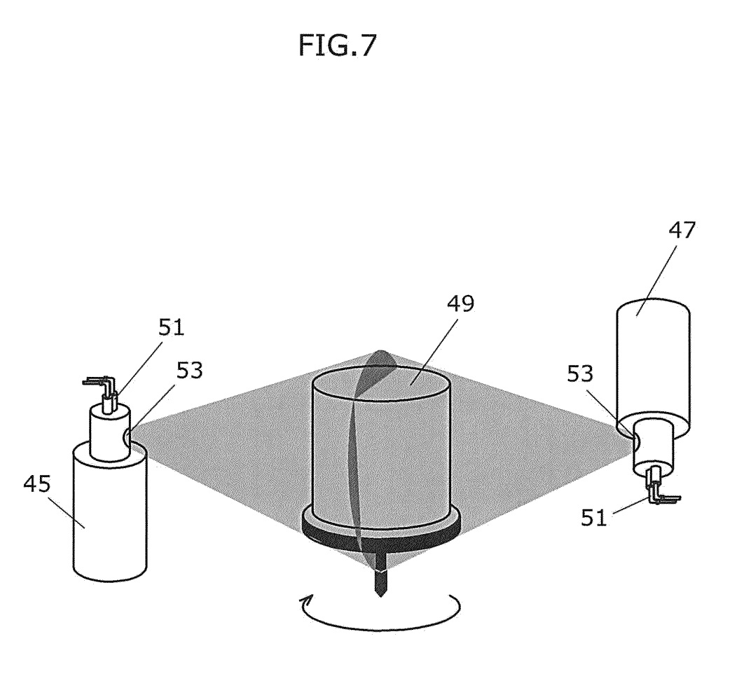

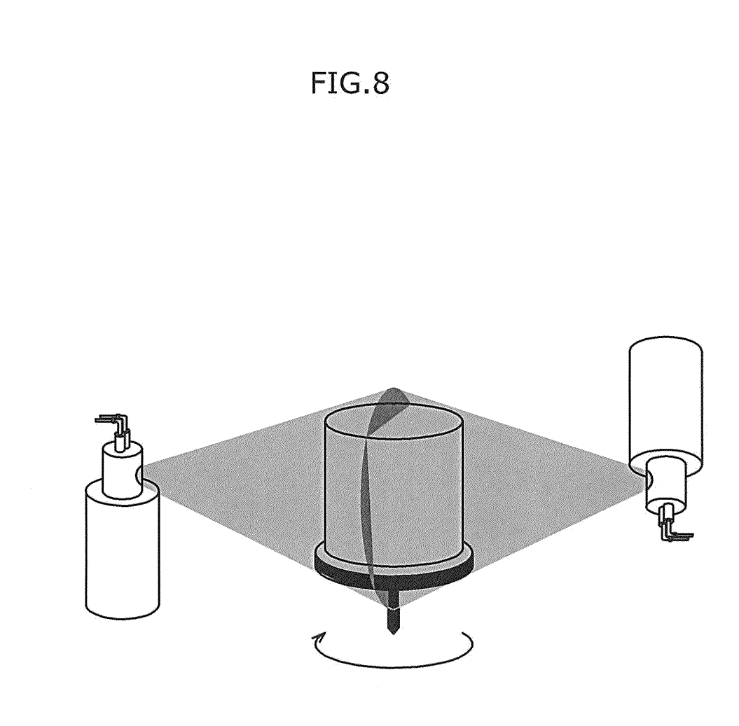

FIG. 7 illustrates the inverted conventional x-ray tubes. The two opposing fixed anode x-ray tubes on opposite sides of a rotating platform aligned anode-to-cathode. Specifically, first x-ray source 45 is setup with anode 51 is on top and the cathode is 53, which is the opposite of the second x-ray source 47. In the second x-ray source 47 the anode 51 is on the bottom and the cathode 53 is on top. Both first x-ray source 45 and second x-ray source 47 are irradiating the blood canister 49. By having in opposite directions, this creates an even distribution dose radiation to the blood canister.

1. A blood irradiator apparatus for evenly irradiating blood bags comprising:
a blood canister, wherein said blood canister holds a blood bag;
an one or more power supply;
an one or more x-ray sources, wherein said one or more x-ray sources are connected individual or together to said one or more power supply;
an one or more motors to rotate said blood canister; and
a vault shield.

2. A blood irradiator apparatus for evenly irradiation blood bags of claim 1 further comprising:
said blood canister is connected to said one or more motors, wherein, said blood canister will rotate in clock-wise or counter clock-wise motion.

3. A blood irradiator apparatus for evenly irradiation blood bags of claim 2 further comprising:
said blood canister is located in the center of said one or more line x-ray sources.

4. A blood irradiator apparatus for evenly irradiation blood bags of claim 2 further comprising:
said blood canister changes the rotation speed conditioned on a single x-ray source or a dual x-ray source.

5. A blood irradiator apparatus for evenly irradiation blood bags of claim 1 further comprising:
said blood canister is connected to an operator control, wherein said operator control changes a rotation speed and a rotation direction or may used predetermined settings.

6. A blood irradiator apparatus for evenly irradiation blood bags of claim 5 further comprising:
said blood canister is connected to an internal cooling system, wherein said internal cooling system cools said blood canister.

7. A blood irradiator apparatus for evenly irradiation blood bags of claim 2 further comprising:
said one or more x-ray sources contain an anode and a cathode.

8. A blood irradiator apparatus for evenly irradiation blood bags of claim 7 further comprising:
said anode and said cathode of a dual x-ray tubes are inverted on opposite sides used to irradiate said blood canister, wherein said dual x-ray tubes provide an even dose distribution.

9. A blood irradiator apparatus for evenly irradiation blood bags of claim 2 further comprising:
said one or more x-ray sources irradiate the entire said blood canister.

10. A blood irradiator apparatus for evenly irradiation blood bags of claim 5 further comprising:
said operator control contains a CPU, a touch display apparatus, and input device, wherein said operator control is connected to said blood irradiator apparatus; and
said operator control monitors internal temperature of the blood irradiator apparatus.

11. A blood irradiator apparatus for evenly irradiation blood bags of claim 8 further comprising:
said dual x-ray sources irradiate said blood canister while the said blood canister is rotating at a predetermined speed.

12. A blood irradiator apparatus for evenly irradiation blood bags of claim 3 further comprising:
said blood canister is being irradiated on the coronal piano and not being irradiated on the transversal piano.

13. A blood irradiator apparatus for evenly irradiation blood bags of claim 2 further comprising:
said one or more x-ray sources contain a line array x-ray tube.

14. A method of irradiating a blood bag in a uniform dose comprising:
spinning a blood canister in a clock-wise or counter clock-wise direction;
irradiating said blood canister while spinning in a rotational direction by using a one or more line x-ray tubes; and
operating an operator control and monitoring said blood canister and said one or more line x-ray tubes.
